(19) United States
(12) Patent Application Publication
(10) Pub. No.: US 2005/0262320 A1
(43) Pub. Date: Nov. 24, 2005

(54) Register unit

(76) Inventors: Makio Kondo, Yokohama (JP); Naoki Sakaguchi, Kawasaki (JP); Toru Senbongi, Yokohama (JP)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/977,103

(22) Filed: Oct. 29, 2004

(30) Foreign Application Priority Data
May 24, 2004 (JP) 2004-153474

(51) Int. Cl. G06F 12/00

(52) U.S. Cl. 711/163

(57) ABSTRACT

A register unit that is capable of improving data security and minimizing the possibility of data alteration and other manipulations includes multiple registers and a bit layout circuit that is connected to the registers. The bit layout circuit stores a relationship table that defines the relationship between the register bit addresses of all the registers and designated bit addresses of addresses that are designated by an arithmetic unit for a read/write operation. Upon receipt of a write command and its data from the arithmetic unit, the bit layout circuit separates the data into bits, generates storage data by rearranging the data in compliance with the relationship table, and stores the generated data at the register bit addresses of registers indicated in the relationship table.

### BACKGROUND OF THE INVENTION

The present invention relates to a register unit that is equipped with a register for use, for instance, in computation.

In recent years, music, picture, and other copyrighted data are stored and distributed by a digital media, which is not subject to data deterioration. Under these circumstances, a technology for protecting copyright holders against the loss of profits, that is, for preventing copyrighted data from being duplicated by another digital method, has been developed (refer, for instance, to JP-A No. 123478/2000).

According to JP-A No. 123478/2000 (FIG. 5), a board is positioned between a card type storage medium on which audio data is recorded and a host computer. The board has a first controller, a second controller, and a memory. The first controller not only transfers audio data from the card type storage medium to the memory, but also transfers redundancy data, which contains a copyright flag, from the card type storage medium to the second controller. If the redundancy data contains a copyright flag, a redundancy area register for the second controller does not output the audio data that has been transferred from the memory.

Under normal conditions, the redundancy area register detects the copyright flag depending on whether the value of the data at a specific position is as specified. Therefore, if the position for storing register data representing a copyright flag is determined by analyzing the redundancy area register, the copyright flag can be disabled. When the copyright flag is disabled, copyrighted data can be freely duplicated.

The present invention has been made in view of the above circumstances and provides a register unit that provides improved data security and minimizes the possibility of alteration and other manipulations.

### SUMMARY OF THE INVENTION

In a first aspect of the present invention, a register unit comprises a register for temporarily storing data that comprises a plurality of bits, and a bit layout circuit for assigning bit addresses to all bits of the register and storing a relationship table, which defines the relationship between the bit addresses and the data bits to be stored in the register. When an instruction for writing data into the register is received, the bit layout circuit separates the data into data bits and writes each data bit at a bit address that is specified according to the relationship table. When an instruction for reading data from the register is received, the bit layout circuit specifies a bit address in accordance with the relationship table, reads each data bit, and outputs reconfigured data. Therefore, the register unit stores the data after rearranging it on an individual bit basis. Even if the data stored in the register is read, it is difficult to identify and read the data that is designated for a write into the register. As a result, the security of data written in the register can be enhanced.

In a second aspect of the present invention, the bit layout circuit of a register unit according to the first aspect of the present invention stores a plurality of relationship tables, and selectively uses a relationship table in accordance with a selection signal received from the outside. Therefore, the register can selectively use a plurality of relationship tables in accordance with a selection signal, making it difficult to decipher data. As a result, the security of data can be enhanced.

In a third aspect of the present invention, the bit layout circuit of a register unit according to the first aspect of the present invention newly creates the relationship table when data stored in the register is received, and stores the created relationship table until a data read is completed in accordance with the relationship table. Therefore, the register cannot easily decipher data because the relationship table changes when a write is performed. As a result, the security of data can be enhanced.

In a fourth aspect of the present invention, the bit layout circuit of a register unit according to the first, second, or third aspect of the present invention extracts necessary data bits, generates blended data, and outputs the blended data in accordance with the relationship table when an instruction for reading data in a plurality of registers is received and the instruction specifies that different data bits of the registers are to be read. Therefore, the register outputs the data to be used. The time required for data transmission can be made shorter than in a case where necessary data is supplied (transmitted) on an individual address basis.

In a fifth aspect of the present invention, the relationship table for a register unit according to the first, second, third, or fourth aspect of the present invention assigns the same bit address to a plurality of data bits that are designated by a write instruction and represent the same value. When a plurality of data bits that always represent the same value are associated with the same bit address in the above manner, the register can exercise integrated management.

In a sixth aspect of the present invention, the relationship table for a register unit according to the first, second, third, fourth, or fifth aspect of the present invention contains data that specifies bit data for which the write is performed with the polarity reversed. Therefore, a data write can be performed with the bit polarity reversed or with the current bit polarity maintained. Even when the data stored in the register is read, the bit polarity required for the use of the data is unknown. As a result, the security of data can be enhanced.

The present invention improves the security of data written in a register and minimizes the possibility of data alteration and other manipulations.

### BRIEF DESCRIPTION OF THE DRAWINGS

FIG. 1 is a block diagram illustrating the configuration of one embodiment of a register according to the present invention.

FIG. 2 illustrates register bit addresses according to one embodiment of the present invention.

FIG. 3 shows relationship tables, which define the relationship between register bit addresses and designated data bits.

FIG. 4 illustrates designated data bits in a first relationship table.

FIG. 5 illustrates designated data bits in a second relationship table.

FIG. 6 is a flowchart illustrating the steps of a write process.

FIG. 7 is a flowchart illustrating the steps of a read process.

FIG. 8 illustrates blended data.

### DETAILED DESCRIPTION OF THE INVENTION

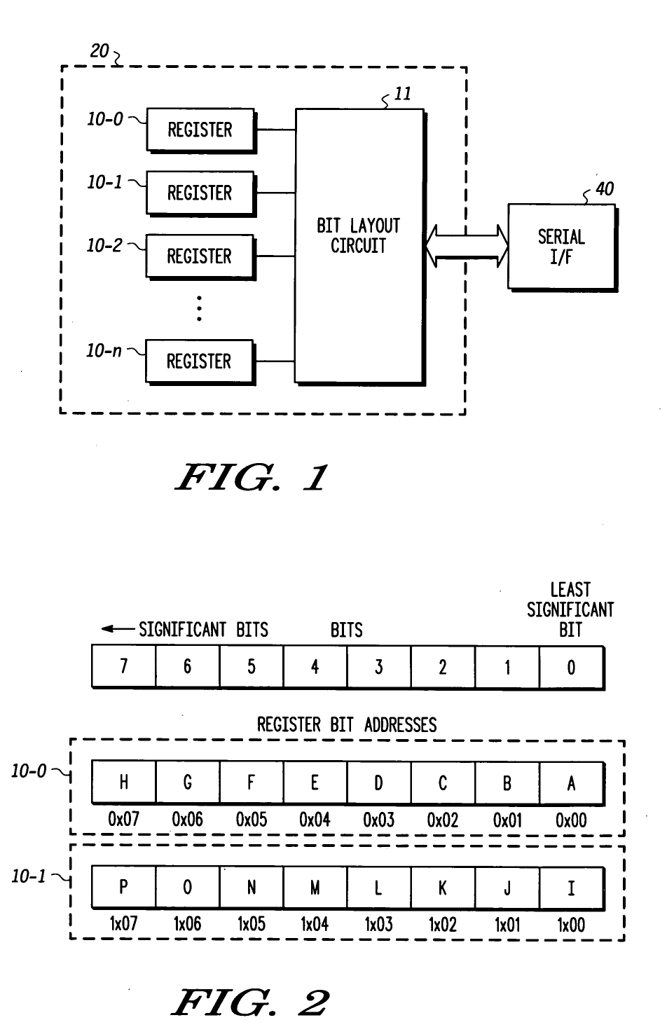

One embodiment of the present invention will now be described with reference to FIGS. 1 through 8. The present embodiment assumes a register unit for managing a register set (register group) that is incorporated in a microprocessor.

A register unit 20 according to the present invention is connected to an arithmetic unit (now shown) via a serial interface 40. In compliance with a command signal from the arithmetic unit, the register unit 20 exercises register management to temporarily store data. As shown in FIG. 1, the register unit 20 comprises a bit layout circuit 11 and a plurality of registers 10-0, 10-1, 10-2, . . . , 10-n, which are connected to the bit layout circuit 11.

The present embodiment uses 8-bit general-purpose registers, which are named “10-0”, “10-1”, and so on to “10-n”. As shown in FIG. 2, the present embodiment manages the registers (10-0 through 10-n) on an individual bit basis. Therefore, each bit is assigned a bit address (hereinafter referred to as a register bit address). In the present embodiment, the register bit addresses for register 10-0 are assigned bit names of A through H in order from the least significant bit to the most significant bit. The register bit addresses for register 10-1 are assigned bit names of I through P.

The bit layout circuit 11 stores data into registers 10-0 through 10-n. More specifically, when the arithmetic unit specifies the data to be written into specific registers, the bit layout circuit 11 separates the data into bits. The separated bits of data are then rearranged and reconfigured. The resulting new data is finally stored at specified bit addresses of registers 10-0 through 10-n.

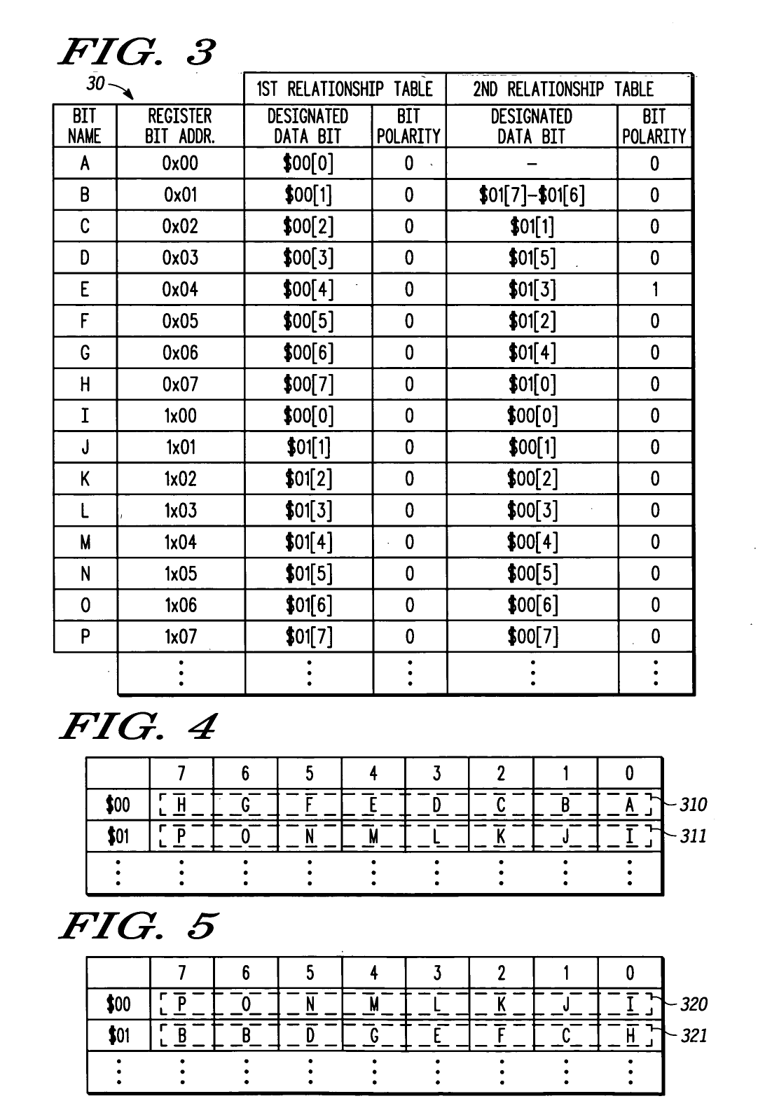

The bit layout circuit 11 incorporates a nonvolatile memory (e.g., EEPROM or flash ROM). The nonvolatile memory stores a relationship table, which is shown in FIG. 3. The relationship table defines the relationship between register bit addresses and the bits of data to be written into the register as specified by the arithmetic unit (hereinafter referred to as designated data bits). Each designated data bit ($n[m]) comprises a register name ($n), which is designated for a write or read, and a bit name. In order from the least significant to the most significant, the bits are named [0], [1], [2], [3], [4], [5], [6], and [7]. In other words, the data to be written into register “$01” comprises designated data bits $01[0] through $01[7].

In the relationship table 30 shown in FIG. 3, two designated data bits correspond to a register bit address. This relationship table 30 comprises a first relationship table and a second relationship table. As described later, the first and second relationship tables are selectively used in compliance with a specific signal received from the arithmetic unit.

In the present embodiment, the first relationship table is such that the designated data bits correspond to FIG. 4 in relation to the register bit addresses shown in FIG. 2. In FIG. 4, the data 310, 311 in the registers (“$00” and “$01”) for use with the first relationship table are expressed with register bit addresses “A” through “P” of registers 10-0 through 10-n. In other words, when the bit layout circuit 11 receives the data to be stored in register “$n” from the arithmetic unit, it writes the data in register 10-n without changing the sequence of the data. Further, when an instruction for reading data in register “$n” is received from the arithmetic unit, the bit layout circuit 11 reads data in register 10-n as is and supplies the read data to the arithmetic unit.

In the second relationship table, on the other hand, the designated data bits are rearranged as shown in FIG. 5 in relation to the register bit addresses shown in FIG. 2. In FIG. 5, the data 320, 321 in the registers (“$00” and “$01”) for use with the second relationship table are expressed with register bit addresses “A” through “P” of registers 10-0 through 10-n. For example, the least significant bit “0” ($01“0”) of data that is designated by the arithmetic unit for a write into register “$01” corresponds to the least significant “C” of register 10-1. Therefore, when the data to be written into register “$n” is received from the arithmetic unit, the bit layout circuit 11 separates the data into bits in accordance with the second relationship table, rearranges the bits, and stores the resulting value in register 10-n. Further, when an instruction for reading data in register “$n” is received from the arithmetic unit, the bit layout circuit 11 reads bit data, which constitutes the register “$n”, from registers 10-0 through 10-n, reconfigures the read bit data, and supplies the reconfigured bit data to the arithmetic unit in compliance with the second relationship table shown in FIG. 3.

In the second relationship table, designated data bits “$01[6]” and “$01[7]” are associated with register bit address “B”. In other words, when the designated data bits constantly represent the same value, the above table can be used.

Further, in the first and second relationship tables shown in FIG. 3, a bit polarity flag is recorded for each designated data bit that corresponds to a register bit address. Bit polarity flag data indicates whether the data is to be stored with its polarity reversed. If the bit polarity flag data is “1” as in the case of “D” at register bit address “0x03” in the second relationship table, the reversal of the associated bit value is recorded in registers 10-0 through 10-n. If the bit polarity flag data is “0”, on the other hand, the data is stored in registers 10-0 through 10-n without reversing its polarity.

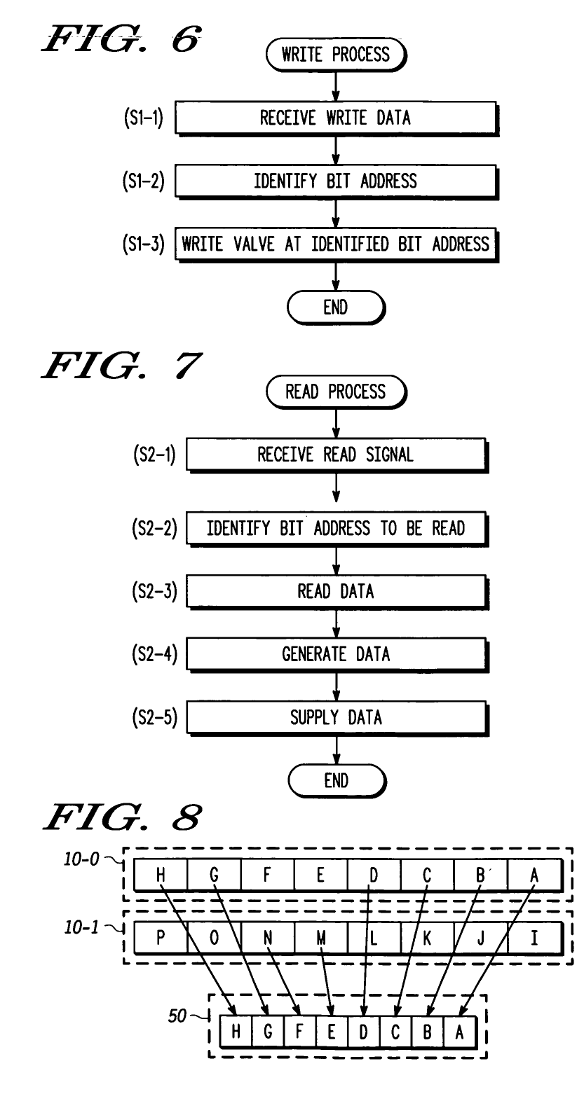

The processes performed by the register unit according to the present embodiment, which is configured as described above, will now be described with reference to FIGS. 6 and 7. First of all, the processes performed by the register unit during a normal operation will be described below.

The first explanation deals with a case where the register unit 20 uses the first relationship table. The second explanation deals with a case where the register unit 20 uses the second relationship table.

Write Process

The bit layout circuit 11 of the register unit 20 receives an instruction for writing data into register “$n” from the arithmetic unit (step S1-1). In this instance, the bit layout circuit 11 identifies register bit addresses for a write in accordance with the first relationship table shown in FIG. 3 (step S1-2). More specifically, the bit layout circuit 11 reads designated data bits ($n[0] through $n[7]) of register “$n” from the first relationship table shown in FIG. 3.

The bit layout circuit 11 then writes data at the identified register bit addresses corresponding to the designated data bits (step S1-3). When, for instance, an instruction for a write into register “$00” is issued, the data at the least significant designated data bit ($00[0]) is written in “A” at register bit address “0x00” in accordance with the first relationship table shown in FIG. 3. Further, the data at the second least significant designated data bit ($00 [1]) is written in “B” at register bit address “0x01”. Similarly, designated data bits $00[2] through $00[7] are written in “C” through “H” at register bit addresses “0x02” through “0x07”.

Read Process

Next, the bit layout circuit 11 receives a signal for reading the data written in register “$n” from the arithmetic unit (step S2-1). In this instance, the bit layout circuit 11 identifies designated data bits constituting register “$n” in accordance with the first relationship table shown in FIG. 3 (step S2-2). The bit layout circuit 11 then reads data from registers 10-0 through 10-n (step S2-3). In accordance with the read data and designated data bits, the bit layout circuit 11 generates the data of register “$n” (step S2-4) and supplies it to the arithmetic unit (step S2-5).

When, for instance, the data in register “$00” is to be read, designated data bits constituting register “$00” are read from registers 10-0 through 10-n in accordance with the first relationship table shown in FIG. 3. The present embodiment records the least significant bit ($00[0]) of “$00” in “A” of register 10-0, the second least significant bit ($00 [1]) of “$00” in “B” of register 10-0, the third least significant bit ($00[2]) of “$00” in “C” of register 10-0, and the other bits ($00[3], $00[4], $00[5], $00[6], and $00[7]) in “D”, “E”, “F”, and “G” of register 10-0, respectively. Therefore, the bit layout circuit 11 reads the values of bits recorded in register 10-0. The bit layout circuit 11 then generates 8-bit data, which is obtained by arranging the read data in the above-mentioned order, as the data for register “$00”, and supplies the generated data to the arithmetic unit.

Next, the processes performed by using the second relationship table will be described. The processes are performed when, for instance, the arithmetic unit reads specific signal data for preventing copyrighted data from being copied. More specifically, when a relationship table selection signal is received from the arithmetic unit, the bit layout circuit 11 uses the second relationship table in place of the first relationship table. In this process, too, the write process and read process are performed in the same manner as described above.

Write Process

The register unit 20 receives write data from the arithmetic unit (step S1-1), identifies a bit address in accordance with the second relationship table shown in FIG. 3 (step S1-2), and writes data at the identified bit address (step S1-3).

When, for instance, data is to be written into register “$00”, the least significant bit ($00[0]) of “$00” is written in “I” of register 10-1 and the second least significant bit ($00 [1]) is written in “J” of register 10-1 in accordance with the second relationship table shown in FIG. 3. The other bits ($00[2], $00[3], $00[4], $00[5], $00[6], and $00[7]) are written in “K”, “L”, “M”, “N”, “O”, and “P”, respectively.

When data is to be written into register “$01”, the data in the least significant bit ($01[0]) is written in “H” in accordance with the second relationship table shown in FIG. 3. Similarly, the second least significant bit ($01[1]) is written in “C”, the third least significant bit ($01[2]) is written in “F”, and the fourth least significant bit ($01[3]) is written in “E”.

Since the bit polarity flag for “E” is “1”, the bit layout circuit 11 writes a value whose bit polarity is reversed, as “E”. More specifically, the bit layout circuit 11 reverses the polarity of “1” and writes the resulting value in “E” when the fourth least significant bit ($01[3]) is “0”. If the fourth least significant bit ($01[3]) is “1”, the bit layout circuit 11 reverses the polarity of “0” and writes the resulting value in “E”.

Further, the bit layout circuit 11 writes the fifth least significant bit ($01[4]) in “G” and the sixth least significant bit ($01[5]) in “D”. The most significant bit ($01[7]) and the second most significant bit ($01[6]) have the same value at all times. Therefore, either of these two values is taken and recorded in “B” (it is assumed herein that the most significant bit ($01[7]) is recorded in

Read Process

The read process performed by using the second relationship table will now be described. In this instance, the bit layout circuit 11 receives a read signal from the arithmetic unit (step S2-1), identifies the bit address to be read in accordance with the second relationship table shown in FIG. 3 (step S2-2), and reads data (step S2-3).

When, for instance, a data read signal for reading the data in register “$00” is received from the arithmetic unit, the register unit 20 reads the data ($00 [m]) recorded by the bits constituting register “$00” from registers 10-0 through 10-n in accordance with the second relationship table shown in FIG. 3. In the present embodiment, the data in register “$00” are entirely recorded in register 10-1 as indicated by the relationship tables in FIG. 3. Therefore, the bit layout circuit 11 reads the values of all bits that are recorded in register 10-1.

The bit layout circuit 11 then arrays the read bits to generate “$00” data (step S2-4), and supplies the generated data to the arithmetic unit (step S2-5).

When a data read signal for reading the data in register “$01” is received from the arithmetic unit, the register unit 20 reads register 10-0, which stores the data of bits constituting register “$01” to be read, in accordance with the second relationship table shown in FIG. 3. More specifically, the register unit 20 performs a read while regarding the data stored in “H” of register 10-0 as the least significant bit ($01[0]), the data stored in “C” of register 10-0 as the second least significant bit ($01 [1]), and the data stored in “F” of register 10-0 as the third least significant bit ($01[2]).

Further, the register unit 20 performs a read while regarding the data stored in “E” of register 10-0 as the fourth least significant bit ($01[3]). Since the bit polarity flag data for “E” in the second relationship table is “1”, the bit layout circuit 11 reverses the polarity of read “E”. More specifically, when the “1” data is stored as “E”, the register unit 20 reads “0” as the fourth least significant bit ($01[3]). When the “0” data is stored as “E”, on the other hand, the register unit 20 reads “1” as the fourth least significant bit ($01[3]).

Furthermore, the register unit 20 reads the data stored in “G” of register 10-0 as the fifth least significant bit ($01[4]) and the data stored in “D” of register 10-0 as the sixth least significant bit ($01[5]).

The register unit 20 also reads the data recorded in “B” of register 10-0 as the most significant bit ($01[7]) and the second most significant bit ($01[6]). The bit layout circuit 11 arrays the read bits to generate the data for register “$01” (step S2-4), and supplies the generated data to the arithmetic unit (step S2-5).

When an identification process for reading specific signal data is completed, the arithmetic unit retransmits a relationship table selection signal to the bit layout circuit 11. The bit layout circuit 11 then uses the first relationship table in place of the second relationship table to perform a data read/write operation for registers 10-0 through 10-n as described above.

As described above, the present embodiment provides the following advantages:
When the second relationship table is used in the present embodiment, the bit layout circuit 11 separates the data in register “$01” into bits, rearranges the resulting separate bit values, and stores the rearranged values in register 10-0. Therefore, it is difficult to read specific data of register “$01” from the data stored in register 10-0. If, for instance, a certain bit of register “$01” is signal data for preventing the duplication of copyrighted data, it is difficult to determine which bit of register 10-0 is such signal data. As a result, it is possible to minimize the possibility of data alteration and other manipulations.

In the present embodiment, the bit layout circuit 11 normally uses the first relationship table shown in FIG. 3 to record data in registers 10-0 through 10-n. When a relationship table selection signal is received from the arithmetic unit for reading specific signal data for the prevention of copyrighted data duplication, the bit layout circuit 11 uses the second relationship table shown in FIG. 3 to record data in registers 10-0 through 10-n. Therefore, even if the relationship between normal register bit addresses and designated data bits, which is defined by the first relationship table, is revealed by an analysis, the identification process uses the second relationship table, which differs from the first relationship table, to define the relationship. Consequently, it is even more difficult to identify the specified data to be recorded in registers 10-0 through 10-n in the identification process. As a result, the security of data can be enhanced.

In the first and second relationship tables used in the present embodiment, the designated data from the arithmetic unit is associated with one register (register between 10-0 and 10-n). Therefore, when the data received from the arithmetic unit is separated and reconfigured, the bit layout circuit 11 writes the data into one register (register between 10-0 and 10-n). After receiving a read signal from the arithmetic unit, the bit layout circuit 11 acquires data from such a corresponding register (register between 10-0 and 10-n), rearranges and reconfigures the acquired data, and supplies the resulting data to the arithmetic unit. Since a read signal for the data at a single address is supplied to the arithmetic unit, it is not necessary to read data from a plurality of registers (registers 10-0 through 10-n).

In the present embodiment, the bit layout circuit 11 records each bit polarity flag in the relationship tables shown in FIG. 3. “E” in the second relationship table, for which a bit polarity flag of “1” is set, is written into register 10-0 with the value of designated data bit $01[3] reversed. When reading $01[3], the bit layout circuit 11 reverses the polarity of the “E” bit. Therefore, when the second relationship table shown in FIG. 3 is used, the register can identify a bit that is reversed when stored. Thus, it is impossible to determine whether the value of a bit recorded in the register is supplied as is to the arithmetic unit or reversed before being supplied to the arithmetic unit. As a result, the security of data can be further enhanced.

When the second relationship table is used in the present embodiment upon receipt of a relationship table selection signal, the bit layout circuit 11 acquires the data at the $01[7] bit address for the designated data bits ($01[6] and $01[7]) and records the acquired data in “B”. When a read signal is received from the arithmetic unit, the bit layout circuit 11 reads the data recorded in [B] of register 10-0 as $01[6] and $01[7]. Therefore, two bits ($01[6] and $01[7]) that always vary while taking on the same value can be collectively managed by using the “B” value for a register bit address.

The present invention is not limited to the foregoing embodiment, but is applicable to the following modifications. The foregoing embodiment has been described on the assumption that the number of data bus bits is equal to the number of bits stored in a single register (register between 10-0 and 10-n). Alternatively, however, the number of bits in registers 10-0 through 10-n may be two or three times the number of data bus bits.

In the foregoing embodiment, the bit layout circuit 11 selectively uses the first and second relationship tables by switching between the first and second relationship tables in accordance with a table selection signal. In a situation where the first relationship table is omitted and the second relationship table is not used, the register unit 20 may be alternatively configured so as to bypass the bit layout circuit 11.

In the foregoing embodiment, the relationship table 30, which is incorporated in the bit layout circuit 11, is used to define the relationship between register bit addresses and designated bit addresses. For the bit layout circuit 11, however, the relationship between register bit addresses and designated bit addresses may be defined without storing the relationship table 30 in advance. More specifically, when the data to be written into registers 10-0 through 10-n is received from the arithmetic unit, the bit layout circuit may separate the data into bits. The bit layout circuit 11 may then determine the sequence of the separated bits by using, for instance, a generated random number, rearrange the bits of data to generate the data for storage, and store the generated data in the register. In this instance, the bit layout circuit 11 internally stores the relationship between the rearranged register bit addresses and designated bit addresses.

The description of the foregoing embodiment deals with a case where the data at each address is read. If, for instance, only some of a plurality of register addresses are required as indicated in FIG. 8, the bit layout circuit 11 may extract necessary portions from a plurality of register data, generate blended data 50 by integrating the extracted data into a single whole, and supply the blended data to the arithmetic unit. More specifically, it is assumed that the “A” and “B” data of register 10-0 are used as indicated in FIG. 8 while the other data of register 10-0 are not used. It also is assumed that the “N” and “M” data of register 10-1 are used while the other data of register 10-1 are not used. In this instance, the bit layout circuit 11 generates blended data 50 when it receives a signal for simultaneously acquiring the data of registers 10-0 and 10-1 from the arithmetic unit. The blended data 50 is obtained by placing the “A” data of register 10-0 in the least significant bit, the “B” data of register 10-0 in the second least significant bit, the “N” data of register 10-1 in the third most significant bit, and the “M” data of register 10-1 in the fourth most significant bit. The blended data 50 obtained in this manner is supplied to the arithmetic unit. As a result, the arithmetic unit receives a smaller amount of data than when it receives all the data stored in registers 10-0 and 10-1. Therefore, the arithmetic unit can receive necessary data within a relatively short period of time.

In the foregoing embodiment, the bit layout circuit 11 separates received data into bits, generates data by rearranging the separated bits, and stores the generated data in the same register (register between 10-0 and 10-n). However, the present invention is not limited to the above case. When the data of a plurality of registers are used simultaneously, the bits may be rearranged alternatively to involve a plurality of registers (registers 10-0 through 10-n).

Description of Symbols
10-0, 10-1, 10-n: Register
11: Bit layout circuit
20: Register unit
50: Blended data

1. A register unit comprising:
a register for temporarily storing data that comprises a plurality of bits; and
a bit layout circuit for assigning bit addresses to all bits of the register and storing a relationship table, which defines a relationship between the bit addresses and the data bits to be stored in the register,
wherein, when an instruction for writing data into the register is received, the bit layout circuit separates the data into data bits and writes each data bit at a bit address that is specified according to the relationship table; and when an instruction for reading data from the register is received, the bit layout circuit specifies a bit address in accordance with the relationship table, reads each data bit, and outputs reconfigured data.

2. The register unit according to claim 1, wherein the bit layout circuit stores a plurality of relationship tables, and selectively uses a relationship table in accordance with a selection signal received from the outside.

3. The register unit according to claim 1, wherein, when data stored in the register is received, the bit layout circuit creates the relationship table, and stores the created relationship table until a data read is completed in accordance with the relationship table.

4. The register unit according to claim 1, 2, r 3, wherein, when an instruction for reading data in a plurality of registers is received and the instruction specifies that different data bits of the registers are to be read, the bit layout circuit extracts necessary data bits, generates blended data, and outputs the blended data in accordance with the relationship table.

5. The register unit according to claim 1, wherein the relationship table assigns the same bit address to a plurality of data bits that are designated by a write instruction and represent the same value.

6. The register unit according to claim 1, wherein the relationship table contains data that specifies bit data for which said write is performed with the polarity reversed.
